(19) United States
(12) Patent Application Publication
(10) Pub. No.: US 2026/0296253 A1
(43) Pub. Date: Oct. 1, 2026

(54) Method for an Electrically Driveable Motor Vehicle for Dynamically Reserving a Charging Point of a Charging Station Comprising Multiple Charging Points, Computer Program, Data Processing Device for a Motor Vehicle, Motor Vehicle, Method for a Server, Server Data Processing Device and Server

(71) Applicant: Bayerische Motoren Werke Aktiengesellschaft, Muenchen (DE)

(72) Inventors: Julian EICHHORN, Muenchen (DE); Adam LANGTON, San Francisco, CA (US)

(21) Appl. No.: 18/881,857

(22) PCT Filed: Aug. 4, 2023
(86) PCT No.: PCT/EP2023/071705

§ 371 Date: Jan. 7, 2025

(30) Foreign Application Priority Data
Aug. 23, 2022 (DE) 10 2022 121 316.1

(51) Int. Cl. B60L 53/66; B60L 53/67; B60L 58/12

(52) U.S. Cl. CPC B60L 53/66; B60L 53/67; B60L 58/12; B60L 2240/72; B60L 2250/16

(57) ABSTRACT

A method for an electrically drivable motor vehicle for dynamically reserving a charging point of a charging station includes detecting a state of charge of an energy storage device, predicting a time of arrival to charge the energy storage device at the charging station, transmitting a reservation request including the time of arrival to a vehicle-external server that manages reservations of the charging point, receiving a reservation response containing an assignment to a first charging point of the charging station in a charging time interval corresponding to the time of arrival. The method also includes ascertaining a change of arrival time based on prediction information captured by the vehicle, transmitting a change request to the server including the change of time of arrival, and receiving a change response ascertained based on reservations of the charging station from the server.

### BACKGROUND AND SUMMARY

The present disclosure relates to a method for an electrically drivable motor vehicle for dynamically reserving a charging point of a charging station comprising multiple charging points for charging an energy storage device of the electrically drivable motor vehicle. The disclosure furthermore relates to a data processing device for a motor vehicle designed to at least partially carry out the method. Furthermore, a motor vehicle having the data processing device is provided. Additionally or alternatively, a computer program is provided that comprises commands which, upon the execution of the program by a computer, prompt it to at least partially carry out the method. Additionally or alternatively, a computer-readable medium is provided that comprises commands which, upon the execution of the commands by a computer, prompt it to at least partially carry out the method. The present disclosure also relates to a method for a server managing reservations of a charging point of a charging station comprising multiple charging points for charging an energy storage device of an electrically drivable motor vehicle. The disclosure furthermore relates to a server data processing device designed to at least partially carry out the method. Furthermore, a server having the data processing device is provided. Additionally or alternatively, a computer program is provided that comprises commands which, upon the execution of the program by a computer, prompt it to at least partially carry out the method. Additionally or alternatively, a computer-readable medium is provided that comprises commands which, upon the execution of the commands by a computer, prompt it to at least partially carry out the method.

Some methods for motor vehicles are known from the prior art.

EP 3 620 751 A2 discloses a device for route planning of an electric vehicle comprising: an input interface for receiving a current state of charge of an energy storage device of the electric vehicle and a planned route of the electric vehicle; a database interface for receiving charging station information having positions of charging stations; an energy planning unit for ascertaining an expected course of the state of charge of the energy storage device based on the current state of charge of the energy storage device and the planned route; a charge planning unit for selecting a charging station based on the expected course of the state of charge, the charging station information, and the planned route; and an adaptation unit for ascertaining at least one adapted route via the position of the selected charging station based on the planned route. Furthermore, the device can comprise a booking unit. This booking unit is used to ascertain an expected arrival time at the selected charging station and to carry out a booking of the selected charging station. A reservation of a charging station is thus performed. The booking unit then transmits a query and receives a confirmation or a rejection as a response. Because the device is suitable for already defining an expected arrival time of a selected charging station beforehand, a reservation of a charging station can take place at the required time. This prevents long waiting times from occurring at the selected charging station.

In particular on comparatively long journeys in which an energy storage device is to be charged once or multiple times, it is desirable to provide simple and flexible management of reservations. During such journeys, the predicted course of the state of charge can sometimes differ significantly from the actually resulting course of the state of charge. For example, because circumstances arise on the long journey after the prediction which were not predicted and/or were not used as a boundary condition for the production, for example, congestion occurring after the prediction, a storm, and/or a rest initiated by the driver. Therefore, it can occur that a booking or reservation cannot be kept.

Against the background of this prior art, an object of the present disclosure is to specify an improved method which is suitable for enhancing the prior art. A specific embodiment of the disclosure can achieve the object of providing improved and more flexible management of reservations for charging an electric vehicle at a charging point of a charging station.

This object is achieved by the features of the present disclosure. The present disclosure also has optional refinements.

Accordingly, this object is achieved by a method for an electrically drivable motor vehicle for dynamically reserving a charging point of a charging station comprising multiple charging points to charge an energy storage device of the electrically drivable motor vehicle. In various embodiments, the method comprises: detecting a state of charge of the energy storage device; predicting an arrival time for charging the energy storage device at the charging station; transmitting a reservation request comprising the arrival time to a vehicle-external server managing reservations of the charging point; receiving, from the server, a reservation response having an assignment of the motor vehicle to a first charging point of the charging station in a charging time interval corresponding to the arrival time; ascertaining an arrival time change on the basis of prediction information detectable at the vehicle; transmitting, to the server, a change request comprising the arrival time change for charging the energy storage device at the charging station according to the arrival time change; and receiving a change response ascertained as a function of reservations of the charging station from the server.

The charging station therefore comprises multiple charging points. The motor vehicle can be charged at each of the charging points if the respective charging point is not already used and/or reserved in another manner. The state of charge is detected in order to estimate a range of the motor vehicle and/or a duration of a future charging process.

The arrival time at the charging station is predicted according to the prior art. In particular, a route can be ascertained, wherein the charging station lies on the route and can be approached by the motor vehicle at the predicted arrival time. The arrival time results, for example, on the basis of road information and/or traffic information relating to the route between the motor vehicle and the charging station.

The reservation request comprising the arrival time is transmitted to a vehicle-external server managing reservations of the charging point. The server manages the reservation of the charging point and can perform a reservation or booking of the charging point in order to be able to provide the charging point for the motor vehicle according to the arrival time for charging. The motor vehicle receives the reservation response from the server as a response to the reservation request. The reservation response comprises an assignment of the motor vehicle to a first charging point in a charging time interval corresponding to the arrival time. The charging time interval defines the charging duration in order to charge the energy storage device. The motor vehicle can thus be charged at the first charging point if the prediction is met.

It has been recognized that the actual arrival time can deviate from an initially predicted arrival time, however. The arrival time change is therefore ascertained on the basis of prediction information detectable at the vehicle. The arrival time change can be ascertained entirely analogously to the prediction of the arrival time. The prediction information is information which is detectable at the vehicle, for example, by sensors, data transfer, and/or user inputs after the prediction of the arrival time, and which enables an updated prediction of the arrival time or the arrival time change.

In order that the prior reservation can be changed accordingly, the change request comprising the arrival time change is transmitted to the server. A charging point or a charging column for charging the energy storage device at the charging station can thus be reserved according to the arrival time change. As a response to the change request, a change response ascertained in dependence on reservations of the charging station is received from the server. It is therefore possible to take into consideration a dynamically changing prediction of the arrival time (estimated time of arrival, ETA).

In other words, it is proposed to provide a charging planning system and method for the motor vehicle which can determine a charging duration for charging the energy storage device and can thus predict a possible further required stop for charging. Reservation requests can be sent out based on the stop for charging in order to dynamically assign a charging point to the motor vehicle according to the arrival time.

The arrival time change can be ascertained at predetermined time intervals. The arrival time change can therefore be ascertained reliably and in a well-defined manner. The time interval can be determined, for example, in consideration of the distance, of speed limits, of a distance between motor vehicle and charging station, and/or traffic information. Alternatively or additionally, the arrival time change can be ascertained under predetermined conditions. For example, stopping of the motor vehicle and subsequent further travel with the motor vehicle can be such a condition. A time has passed between the stopping and the further travel in which facts relevant for the prediction of the arrival time have changed.

The prediction data can comprise vehicle-related data, surroundings-related data, and/or user input data. Vehicle-related data are, for example, items of information relating to the status of the motor vehicle, for example, relating to the state of charge, which can develop deviating from the prediction due to the driving style and/or a loading of the motor vehicle. Surroundings-related data relate to the surroundings of the motor vehicle. Surroundings-related data characterize, for example, traffic, a roadway, and/or weather. Surroundings-related data can be detected by vehicle-side sensors and/or transmitted from an external server to the motor vehicle. User input data comprise, for example, preferences of a driver and/or user and can comprise the actuation of the motor vehicle. For example, user input data can correspond to an operating mode (e.g., eco, tour, sport) of the motor vehicle and/or a driver assistance function. A comprehensive prediction is thus possible.

The method can comprise: outputting change information corresponding to the change response for perception by a driver and/or user of the motor vehicle. The motor vehicle can have an output device for this purpose. The change response informs the driver and/or user. Optionally, a user input confirming or rejecting the change response can take place.

The change response can comprise an assignment of the motor vehicle to the first charging point in a changed charging time interval corresponding to the arrival time change. In this case, there is also the possibility at an arrival time changed according to the arrival time change of charging the energy storage device at the first charging point. The charging time interval is therefore simply shifted, for example. Alternatively, the change response can comprise an assignment of the motor vehicle to a second charging point, which is different from the first charging point, in the changed charging time interval. In this case, the possibility of charging the energy storage device at the first charging point is not provided at an arrival time changed according to the arrival time change; however, the second charging point of the charging station is available. The reservation is therefore adapted within the charging station and optionally the charging time interval is shifted. Alternatively, the change response can comprise a rejection. In this case, there is no possibility at an arrival time changed according to the arrival time change of charging the energy storage device at one of the charging points of the charging station without a waiting time. The reservation is accordingly canceled in order to make the charging point reservable for other motor vehicles, a waiting time for charging is offered to the driver and/or user of the motor vehicle and/or a route to another charging station is offered to the driver and/or user of the motor vehicle.

Furthermore, a computer program comprising commands which, upon the execution of the program by a computer, prompt it to at least partially execute or carry out the above-described method for the motor vehicle is provided.

A program code of the computer program can be present in any arbitrary code, in particular in a code which is suitable for controllers of motor vehicles.

The description above with reference to the method for the motor vehicle also applies analogously to the computer program and vice versa.

Furthermore, a data processing device, e.g. a control unit, for the motor vehicle is provided, wherein the data processing device is configured to at least partially execute or carry out the above-described method for the motor vehicle. The method for the motor vehicle is thus a computer-implemented method.

The data processing device can be an electronic control unit (ECU). The electronic control unit can be an intelligent processor-controlled unit which can communicate with other modules, for example, via a central gateway (CGW) and can optionally form the vehicle onboard network via field buses, such as the CAN bus, LIN bus, MOST bus, and FlexRay or via automotive ethernet, for example, together with telematics control units. It is conceivable that the control unit controls functions, such as the in particular motor control, the force transmission, relevant for the driving behavior of the motor vehicle, and/or regulates a charging process.

The description above with reference to the method for the motor vehicle and to the computer program also applies analogously to the data processing device and vice versa.

Furthermore, a motor vehicle comprising the above-described data processing device is provided.

The motor vehicle can be a passenger vehicle, in particular an automobile. The optionally automated motor vehicle can be an electrically drivable motor vehicle. The motor vehicle can comprise an electric drive for this purpose, to which electrical energy provided by the energy storage device can be applied to drive the motor vehicle.

The description above with reference to the method for the motor vehicle, to the data processing device, and to the computer program also applies analogously to the motor vehicle and vice versa.

Furthermore, a computer-readable medium, in particular a computer-readable storage medium, is provided. The computer-readable medium comprises commands which, upon the execution of the program by a computer, prompt it to at least partially carry out the above-described method for the motor vehicle.

That is to say, a computer-readable medium can be provided which comprises an above-defined computer program. The computer-readable medium can be any digital data storage device, such as a USB stick, a hard drive, a CD-ROM, an SD card, or an SSD card. The computer program does not necessarily have to be stored on such a computer-readable storage medium in order to be provided to the motor vehicle, but rather can also be acquired externally via the Internet or in another way.

The description above with respect to the method for the motor vehicle, to the data processing device, to the computer program, and to the motor vehicle also applies analogously to the computer-readable medium and vice versa.

Furthermore, a method for a server managing reservations of a charging point of a charging station comprising multiple charging points for charging an energy storage device of an electrically drivable motor vehicle is provided. In various embodiments, the method comprises: receiving a reservation request comprising an arrival time from the electrically drivable motor vehicle, wherein the arrival time is an arrival time predicted at the vehicle; transmitting a reservation response with an assignment of the motor vehicle to a first charging point of the charging station in a charging time interval corresponding to the arrival time; receiving a change request comprising an arrival time change to charge the energy storage device at the charging station according to the arrival time change; ascertaining a change response in dependence on reservations of the charging station; and transmitting the change response to the motor vehicle.

Furthermore, a computer program comprising commands which, upon the execution of the program by a computer, prompt it to at least partially execute or carry out the above-described method for the server is provided.

A program code of the computer program can be provided in any code, in particular in a code which is suitable for controllers of motor vehicles.

The description above with respect to the method for the server also applies analogously to the computer program and vice versa.

Furthermore, a server data processing device is provided, wherein the server data processing device is configured to at least partially execute or carry out the above-described method for the server. The method for the server is therefore a computer-implemented method.

The description above with respect to the method for the server and to the computer program also applies analogously to the server data processing device and vice versa.

Furthermore, a server comprising the above-described server data processing device is provided.

The description above with respect to the method for the server, to the server data processing device, and to the computer program also applies analogously to the server and vice versa.

The server can be a server managing reservations of multiple charging stations. The server is therefore a central server. The server can manage reservations for charging stations and/or charging points of multiple producers and/or providers.

Alternatively or additionally, the server can be a server managing reservations of multiple charging points of a charging station. Local management of the reservation is thus possible. The server can be connectable and/or connected to other servers of other charging stations in order to exchange reservation information.

Alternatively or additionally, the server can be a server managing reservations of a charging point of a charging station. The server can be implemented directly in the charging point or the charging column. Easy installation of the server is thus possible. The server can be connectable and/or connected to other servers of other charging points and/or charging stations in order to exchange reservation information.

Furthermore, a computer-readable medium, in particular a computer-readable storage medium, is provided. The computer-readable medium comprises commands which, upon the execution of the program by a computer, prompt it to at least partially carry out the above-described method for the server.

That is to say, a computer-readable medium can be provided which comprises an above-defined computer program. The computer-readable medium can be any digital data storage device, such as a USB stick, a hard drive, a CD-ROM, an SD card, or an SSD card. The computer program does not necessarily have to be stored on such a computer-readable storage medium in order to be provided to the motor vehicle, but rather can also be acquired externally via the Internet or in another way.

The description above with respect to the method for the server, to the server data processing device, to the computer program, and to the server also applies analogously to the computer-readable medium and vice versa.

An embodiment is described hereinafter with reference to FIGS. 1 to 7.

### BRIEF DESCRIPTION OF THE DRAWINGS

FIG. 1 schematically shows an overview of a motor vehicle according to one aspect of the disclosure;

FIG. 2 schematically shows state of charge predictions of a motor vehicle according to one aspect of the disclosure;

FIG. 3 schematically shows a dynamic reservation of a charging point by a motor vehicle according to one aspect of the disclosure;

FIG. 4 schematically shows a sequence of a method for a motor vehicle;

FIG. 5 schematically shows a sequence of a method for a server;

FIG. 6 schematically shows a reservation of a charging station; and

FIG. 7 schematically shows an input request.

### DETAILED DESCRIPTION OF THE DRAWINGS

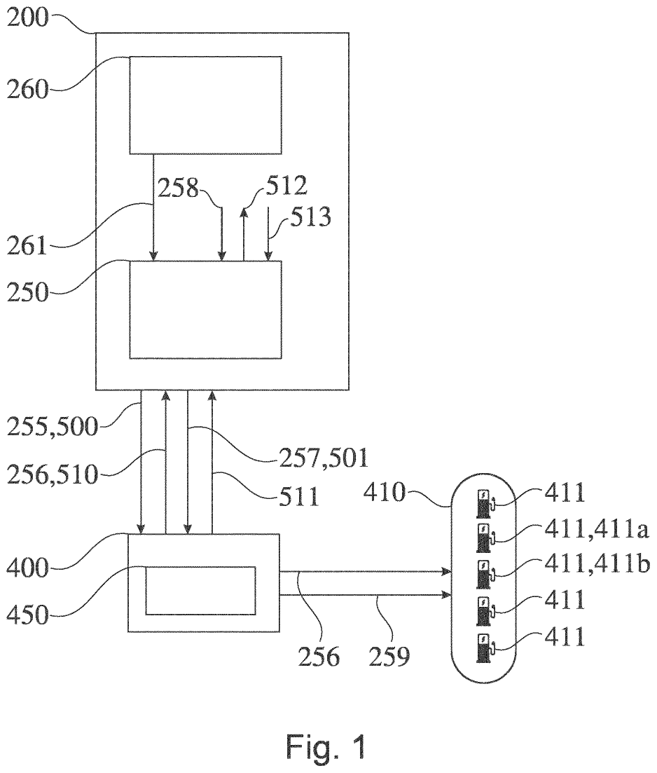

FIG. 1 schematically shows an overview of a motor vehicle 200 according to one aspect of the disclosure. FIG. 1 moreover shows a server 400 and a charging station 410 having multiple charging points 411.

The motor vehicle 200 is an electrically drivable motor vehicle 200 and has a rechargeable energy storage device 260 for storing and providing electrical energy. The energy storage device 260 is in particular rechargeable at the charging station 410.

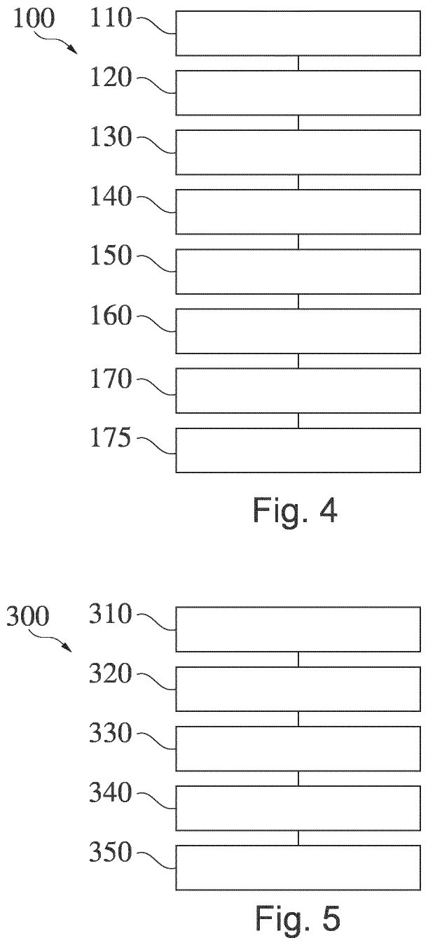

The motor vehicle 200 has a data processing device 250, which is configured to carry out the steps of the method 100 according to FIG. 4. For this purpose, the data processing device 250 according to FIG. 1 is configured to detect a state of charge 261 of the energy storage device 260.

The data processing device 250 is furthermore configured to detect prediction information 258. The prediction data 258 comprise vehicle-related data, surroundings-related data, and user input data. For this purpose, the motor vehicle 200 has in each case a sensor device connected to the data processing device 250, communication devices for wireless communication, and an input device. The sensor device is configured to sense information relating the motor vehicle 200, the surroundings and/or a user and/or driver of the motor vehicle. For example, the sensor device can have one or more cameras for this purpose. The communication device is configured to receive data relating to the motor vehicle 200 and/or the surroundings. For example, information on congestion, traffic, and/or weather can thus be transmitted to the motor vehicle 200. The input device is for input of information by the driver and/or user. Information on a driving mode and/or on route planning can be input here, for example.

The data processing device 250 is configured to predict an arrival time 255 for charging the energy storage device 260 at the charging station 410 on the basis of the prediction information 258 and thereupon to transmit a reservation request 500 comprising the arrival time 225 to the vehicle-external server 400 managing reservations of the charging point 411. The reservation request 500 and an assignment of the motor vehicle 200 to one of the charging points 411 taking place thereupon can take into consideration a user input and/or preset of preferences. The reservation request 500 can comprise dynamic data and static data. Static data are permanently defined during a journey with the motor vehicle 200 and comprise, for example, information relating to the vehicle, a compatibility of the vehicle with charging points 411, a capacity of the energy storage device 260, and/or a method of payment. Dynamic data can change during a journey with the motor vehicle 200 and comprise, for example, a predicted state of charge upon arrival at the charging point in order to determine a charging duration.

The server 400 checks the possibility of charging the motor vehicle 200 at the charging station 410 and transmits a reservation response 510 with an assignment of the motor vehicle 200 to a first charging point 411a of the charging station 410 in a charging time interval 256 corresponding to the arrival time 255. The reservation response 510 is received by the motor vehicle 510. The charging time interval 256 can be transmitted from the server 400 to the charging station 410 and/or the first charging point 411a.

The data processing device 250 is configured to carry out an arrival time change 257 on the basis of the prediction information 258. For this purpose, a renewed prediction is created analogously to the arrival time 255. The data processing device 250 thereupon transmits to the server 400 a change request 501, comprising the arrival time change 257, for charging the energy storage device 260 at the charging station 410 according to the arrival time change 257.

The arrival time 257 is calculated permanently or regularly. The change request 501 based thereon can be transmitted at regular time intervals and/or under a predetermined condition from the motor vehicle 200 to the server 400, for example, if an arrival time change 257 comprises more than 2 min in absolute value. Additionally or alternatively, the change request 501 can be transmitted more frequently from the motor vehicle 200 to the server 400 upon geographic and/or temporal approach to the charging station 400.

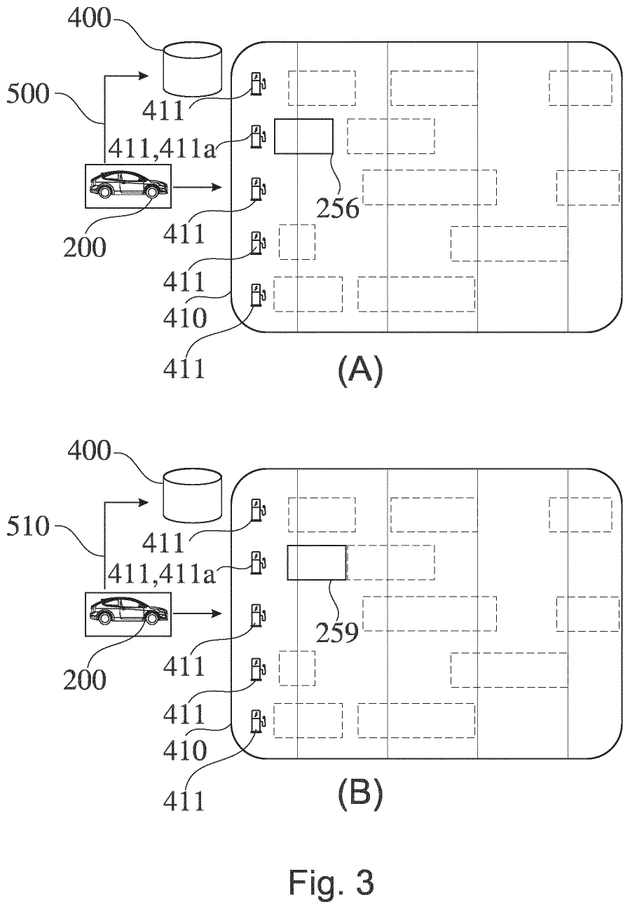

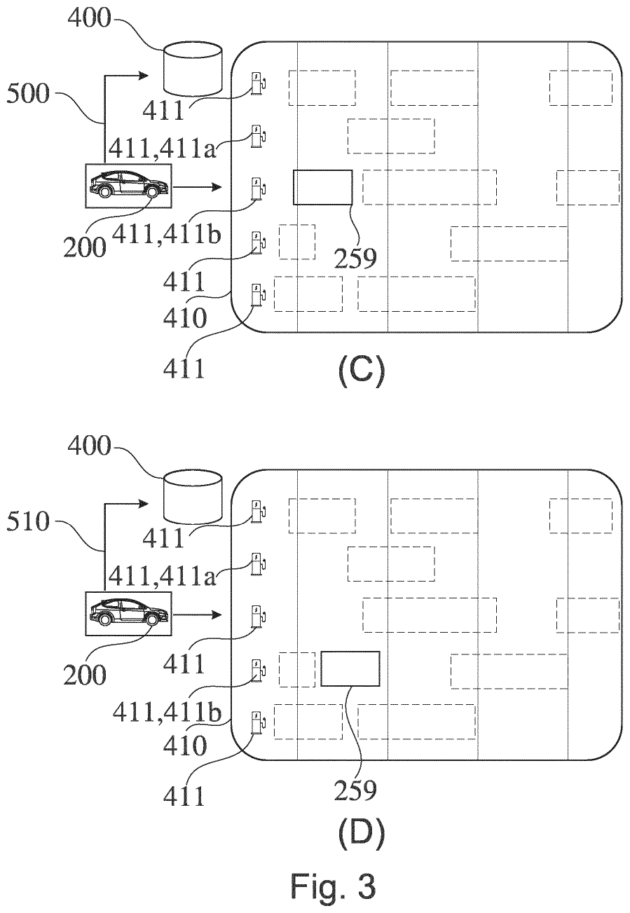

The server 400 checks the possibility of charging the motor vehicle 200 at the charging station 410 and transmits a change response 511. The change response 511 is received by the motor vehicle 510. A possibly changed charging time interval 259 can be transmitted from the server 400 to the motor vehicle 200, the charging station 410, and/or one of the plurality of charging points 411. Various possible scenarios with respect to the change response 511 are described with reference to FIG. 3.

The data processing device 250 is configured to output change information 512 corresponding to the change response 511 for perception by a driver and/or user of the motor vehicle 200. For this purpose, the motor vehicle 200 has an output device (not shown), for example, a display for visual output and/or a loudspeaker for acoustic output. The user and/or driver can optionally perform an input 513 according to the change information 512 in order to accept or reject the change. The change information 512 can be output with an input request 514 (see FIG. 7). The input request 514 can comprise a confirmation 515 of a waiting time and/or a request 516 to look for another charging station 410 on a route. The change information 512 can comprise the charging point 411, for example, “charging column 3”. Optionally, the server 400, in particular upon approach to the charging station 410, can cause reservation information, for example a user name and/or information relating to a license plate number of the motor vehicle 200, to be displayed at the charging point 411.

The communication between the motor vehicle 200 and the server 400 can take place, for example, via a mobile wireless network (4G, 5G) and/or a local wireless network (WLAN).

The server 400 has a server data processing device 450 to manage reservations of a charging point 411 of a charging station 410 comprising multiple charging points 411 for charging the energy storage device 260 of the electrically drivable motor vehicle 200. The server 400 can be a central server 400 here, thus a server 400 managing reservations of multiple charging stations 410. Producer-spanning and/or service provider-spanning management of the reservations can thus take place, for example. The server 400 can be a partially central server 400, thus a server 400 managing reservations of multiple charging points 411 of a charging station 410. Local management of the reservations of the charging station 410 is thus effectively possible. The server 400 can be connected and/or connectable in this case to other servers 400 of other charging stations 410 in order to exchange reservation information. The server 400 can be a decentralized server 400, thus a server 400 managing reservations of one charging point 411 of a charging station 410. For example, the server 400 can then be arranged directly in the respective charging point 411 or the charging column. Local management of the reservations of the respective charging point 411 is thus effectively possible. The server 400 can be connected and/or connectable in this case to other servers 400 of other charging points 411 and/or other charging stations 410 in order to exchange reservation information. The server data processing device 450 is configured to carry out the steps of the method 300 according to FIG. 5.

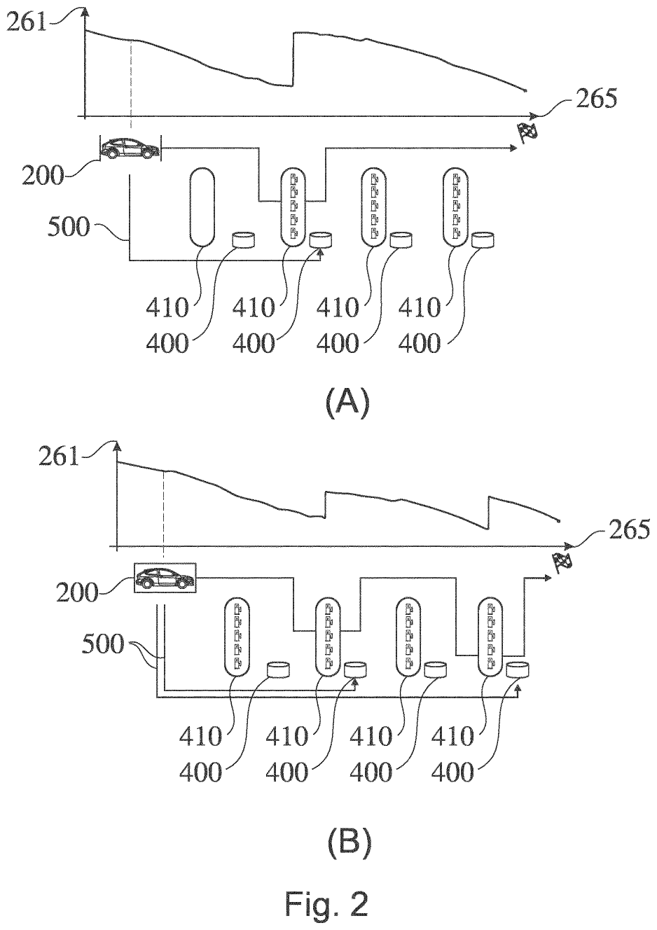

FIG. 2 schematically shows state of charge predictions of a motor vehicle 200 according to one aspect of the disclosure. FIG. 2 (A) and FIG. 2 (B) each show a scenario for a prediction of a state of charge 261 of an energy storage device 260 of a motor vehicle 200 in dependence on a route 265 to be driven. Such a motor vehicle 200 is described in FIG. 1, to which reference is made in the description of FIG. 2.

In a respectively upper image section of FIG. 2 (A) and 2 (B), a curve is shown, which shows the state of charge 261 in dependence on a route 265. The motor vehicle 200 is located at a point represented by a vertically arranged, dashed line on the route 265. The state of charge 261 at this point can be measured at the vehicle. The state of charge 261 is than predicted. In order to reach a destination illustrated by a destination flag on the route 265, the energy storage device 260 has to be charged along the route 265.

For this purpose, the motor vehicle 200 according to FIG. 2 (A) transmits a reservation request 500 to a server 400, which manages reservations of one of multiple charging stations 410 arranged along the route 265. The motor vehicle 200 charges at the charging station 410, the state of charge 261 rises upon the charging and the motor vehicle 200 can continue the journey along the route 265.

According to FIG. 2 (B), the motor vehicle 200 has to be charged at two charging stations 410. For this purpose, the motor vehicle 200 transmits a reservation request 500 in each case to a respective server 400, which manages reservations of one of multiple charging stations 410 arranged along the route 265. The motor vehicle 200 charges at the charging stations 410, the state of charge 261 rises upon the charging in each case and the motor vehicle 200 can continue the journey along the route 265.

However, it can occur that the prediction is not observed and a reservation corresponding to the reservation request 500 with respect to one of the charging stations 410 cannot be observed. For this purpose, the dynamic reservation described with reference to FIGS. 1 and 3 to 5 is applied, which takes into consideration a change of the arrival time 255.

FIG. 3 schematically shows a dynamic reservation of a charging point 411, 411a, 411b by a motor vehicle 200 according to one aspect of the disclosure. FIG. 3 (A) to 3 (D) each show a scenario for an assignment of the motor vehicle 200 to one of the charging points 411, 411a, 411b of the charging station 410. Such a motor vehicle 200 is described in FIG. 1. In the description of FIG. 3, reference is made to FIGS. 1 and 2 and their description.

Each of FIG. 3 (A) to 3 (D) illustrates the occupancy of the charging points 411 of the charging station 410. The charging points 411 are plotted in lines and occupancies of the respective charging point 411 associated with the respective charging point 411 and represented by rectangles having dashed lines are illustrated in each line. The arrangement and size of the rectangles represents the time and the duration in which the respective charging point 411 is occupied by another motor vehicle 200 and is not available for a reservation.

According to FIG. 3 (A), the motor vehicle 200 transmits the reservation request 500 to the server 400. The server 400 reserves a charging time interval 256 at a first charging point 411a of the charging station 410 in accordance with the predicted arrival time 255. The charging time interval 256 is defined by a starting time and an end time and/or by one of the two times and a charging duration.

The arrival time 255 can change, however. The motor vehicle 200 ascertains the arrival time change 257 and transmits a change request 510 to the server 400 according to FIG. 3 (B) to 3 (D).

According to FIG. 3 (B), the server 400 reserves a changed charging time interval 258 at the first charging point 411a of the charging station 410 in accordance with the arrival time change 257. It was ascertained that the changed charging time interval 258 requested by the motor vehicle 200 in accordance with the state of charge 261 and the route 265 is sufficient to only shift the reservation of the first charging point 411a. Optionally, the changed charging time interval 258 can be shortened in relation to the original charging time interval 256 in order to enable charging at all.

According to FIG. 3 (C) and 3 (D), the server 400 reserves a changed charging time interval 258 at a second charging point 411b of the charging station 410, which is different from the first charging point 411a, in accordance with the arrival time change 257. It was ascertained that the changed charging time interval 258 requested by the motor vehicle 200 in accordance with the state of charge 261 and the route 265 is sufficient to shift the reservation within the charging station 410 to the second charging point 411b. Optionally, the changed charging time interval 258 can be shortened in relation to the original charging time interval 256 in order to enable charging at all.

If the motor vehicle 200 is charged at one of the charging points 411, information relating to the charging, for example, a remaining charging time, can be output at the charging point 411 by an output device of the charging point 411.

FIG. 4 schematically shows a sequence of a method 100 for a motor vehicle 200. The method 100 is a method 100 for an electrically drivable motor vehicle 200 for dynamically reserving a charging point 411 of a charging station 410 comprising multiple charging points 411 for charging an energy storage device 260 of the electrically drivable motor vehicle 200. Such a motor vehicle 200 is described with reference to FIG. 1. FIG. 4 is described with reference to FIGS. 1 to 3 and their description.

The method 100 comprises detecting 110 a state of charge 261 of the energy storage device 260.

An arrival time 255 for charging the energy storage device 260 at the charging station 410 is predicted 120.

A reservation request 500 comprising the arrival time 225 is transmitted 130 to a vehicle-external server 400 managing reservations of the charging point 411.

A reservation response 510 having an assignment of the motor vehicle 200 to a first charging point 411a of the charging station 410 in a charging time interval 256 corresponding to the arrival time 255 is received 140 from the server 400.

An arrival time change 257 is ascertained 150 on the basis of prediction information 258 detectable at the vehicle. The ascertainment 150 of the arrival time change 257 takes place at predetermined time intervals and/or under predetermined conditions. The prediction data 258 comprise vehicle-related data, surroundings-related data, and/or user input data.

A change request 501 comprising the arrival time change 257 for charging the energy storage device 260 at the charging station 410 according to the arrival time change 257 is transmitted 160 to the server 400.

A change response 511 ascertained in dependence on reservations of the charging station 410 is received 170 from the server 400.

Change information 512 corresponding to the change response 511 is output 175 for perception by a driver and/or user of the motor vehicle 200. The change response 511 comprises an assignment of the motor vehicle 200 to the first charging point 411a in a charging time interval 258 changed in accordance with the arrival time change 257, an assignment of the motor vehicle 200 to a second charging point 411b different from the first charging point 411a in the changed charging time interval 258, or a rejection.

FIG. 5 schematically shows a sequence of a method 300 for a server 400. The method 300 is a method 300 for a server 400 managing reservations of a charging point 411 of a charging station 410 comprising multiple charging points 411 for charging an energy storage device 260 of an electrically drivable motor vehicle 200. Such a server 400 is described with reference to FIG. 1. FIG. 5 is described with reference to FIGS. 1 to 4 and their description.

The method 300 comprises receiving 310 a reservation request 500 comprising an arrival time 255 from the electrically drivable motor vehicle 200, wherein the arrival time 255 is an arrival time 255 predicted at the vehicle.

A reservation response 510 having an assignment of the motor vehicle 200 to a first charging point 411 of the charging station 410 in a charging time interval 256 corresponding to the arrival time 255 is transmitted 320.

A change request 501 comprising an arrival time change 257 for charging the energy storage device 260 at the charging station 410 according to the arrival time change 257 is received 330.

A change response 511 is ascertained 340 in dependence on reservations of the charging station 410.

The change response 511 is transmitted 350 to the motor vehicle 200.

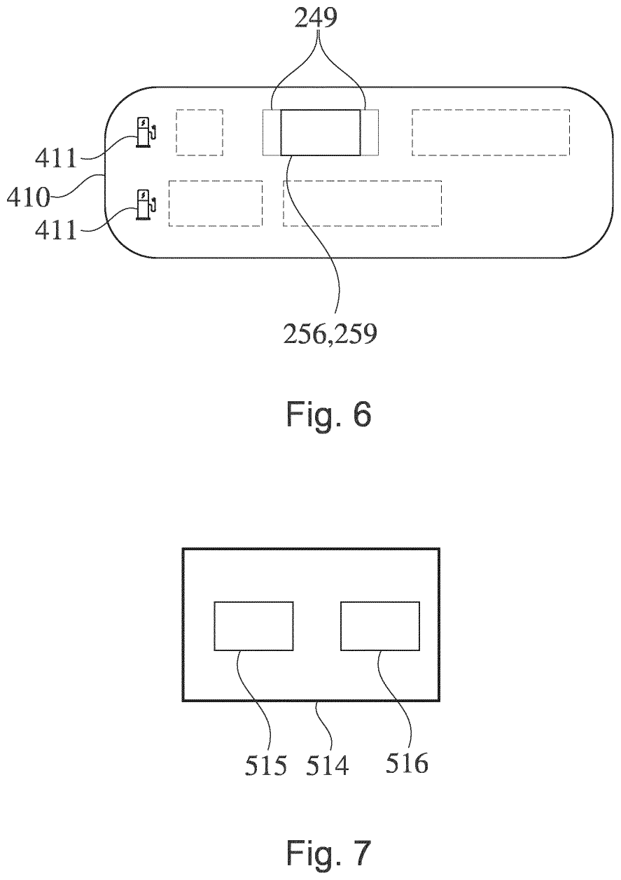

FIG. 6 schematically shows a reservation of a charging station 410 having two charging points 411. FIG. 6 is described with reference to FIG. 3.

FIG. 6 shows that in the case of a reservation of a charging time interval 256 and/or a changed charging time interval 259, a buffer 249 can be planned in and/or reserved. The buffer 249 can be, for example, a few minutes, in particular 5 minutes. It is therefore possible that motor vehicles which are possibly previously charging have vacated the charging point 411 at the beginning of the charging time interval 256 and/or changed charging time interval 259 and immediate charging of the motor vehicle 200 can take place.

FIG. 7 schematically shows an input request 514. The input request 514 comprises a confirmation 515 of a waiting time and a request 516 to search for another charging station 410 on a route.

### LIST OF REFERENCE SIGNS

100 method for a motor vehicle 110 detecting
120 predicting
130 transmitting a reservation request
140 receiving a reservation response
150 ascertaining
160 transmitting a change request
170 receiving a change response
175 outputting
200 motor vehicle
249 time buffer
250 data processing device
255 arrival time
256 charging time interval
257 arrival time change
258 prediction information
259 changed charging time interval
200 motor vehicle
260 energy storage device
261 state of charge
265 route
300 method for a server
310 receiving a reservation request
320 transmitting a reservation response
330 receiving a change request
340 ascertaining
350 transmitting a change response
400 server
410 charging station
411 charging point
411a first charging point
450 server data processing device
500 reservation request
501 change request
510 reservation response
511 change response
512 change information
513 input
514 input request
515 confirmation
516 request

1-12. (canceled)

13. A method for an electrically drivable motor vehicle for dynamically reserving a charging point of a charging station comprising multiple charging points for charging an energy storage device of the electrically drivable motor vehicle, the method comprising:
detecting a state of charge of the energy storage device;
predicting an arrival time for charging the energy storage device at the charging station;
transmitting a reservation request comprising the arrival time to a vehicle-external server managing reservations of the charging point;
receiving, from the server, a reservation response having an assignment of the motor vehicle to a first charging point of the charging station in a charging time interval corresponding to the arrival time;
ascertaining an arrival time change on a basis of prediction information detectable at the vehicle;
transmitting, to the server, a change request comprising the arrival time change for charging the energy storage device at the charging station according to the arrival time change; and
receiving a change response ascertained in dependence on reservations of the charging station from the server.

14. The method according to claim 13, wherein the arrival time change is ascertained at predetermined time intervals and/or under predetermined conditions.

15. The method according to claim 13, wherein information comprise vehicle-related data, surroundings-related data, and/or user input data.

16. The method according to claim 13, comprising:
outputting change information corresponding to the change response for perception by a driver and/or user of the motor vehicle.

17. The method according to claim 13,
wherein the change response comprises an assignment of the motor vehicle to the first charging point in a charging time interval changed in accordance with the arrival time change, an assignment of the motor vehicle to a second charging point that is different from the first charging point in the changed charging time interval, or a rejection.

18. A non-transitory computer-readable medium having stored thereon a computer program comprising commands which, upon execution of the program or the commands by a computer, cause the computer to carry out the method according to claim 13.

19. A data processing device for a motor vehicle configured to:
detect a state of charge of an energy storage device of the motor vehicle;
predict an arrival time for charging the energy storage device at a charging station;
transmit a reservation request comprising the arrival time to a vehicle-external server managing reservations of a charging point of the charging station;
receive, from the server, a reservation response having an assignment of the motor vehicle to a first charging point of the charging station in a charging time interval corresponding to the arrival time;
ascertain an arrival time change on a basis of prediction information detectable at the vehicle;
transmit, to the server, a change request comprising the arrival time change for charging the energy storage device at the charging station according to the arrival time change; and
receive a change response ascertained in dependence on reservations of the charging station from the server.

20. The data processing device according to claim 19, further configured to:
ascertain the arrival time change at predetermined time intervals and/or under predetermined conditions.

21. The data processing device according to claim 19, wherein the prediction information comprises vehicle-related data, surroundings-related data, and/or user input data.

22. The data processing device according to claim 19, further configured to:
output change information corresponding to the change response for perception by a driver and/or user of the motor vehicle.

23. The data processing device according to claim 19,
wherein the change response comprises an assignment of the motor vehicle to the first charging point in a charging time interval changed in accordance with the arrival time change, an assignment of the motor vehicle to a second charging point that is different from the first charging point in the changed charging time interval, or a rejection.

24. A motor vehicle comprising:
the data processing device according to claim 19.

25. A method for a server managing reservations of a charging point of a charging station comprising multiple charging points for charging an energy storage device of an electrically drivable motor vehicle, the method comprising:
receiving a reservation request comprising an arrival time from the electrically drivable motor vehicle, wherein the arrival time is an arrival time predicted at the vehicle;
transmitting a reservation response having an assignment of the motor vehicle to a first charging point of the charging station in a charging time interval corresponding to the arrival time;
receiving a change request comprising an arrival time change for charging the energy storage device at the charging station according to the arrival time change;
ascertaining a change response in dependence on reservations of the charging station; and
transmitting the change response to the motor vehicle.

26. The method according to claim 25,
wherein the change response comprises an assignment of the motor vehicle to the first charging point in a charging time interval changed in accordance with the arrival time change, an assignment of the motor vehicle to a second charging point that is different from the first charging point in the changed charging time interval, or a rejection.

27. A server data processing device for a server, wherein the server data processing device is configured to carry out the method according to claim 25.

28. A server comprising the server data processing device according to claim 27.

29. The server according to claim 28, wherein the server is a server managing reservations of multiple charging stations, a server managing reservations of multiple charging points of a charging station, and/or a server managing reservations of a charging point of a charging station.
